(19) United States
(12) Patent Application Publication
(10) Pub. No.: US 2017/0032325 A1
(43) Pub. Date: Feb. 2, 2017

(54) ENTITY AWARE SNIPPETS

(71) Applicant: Linkedln Corporation, Mountain View, CA (US)

(72) Inventors: Ganesh Venkataraman, San Jose, CA (US); Dhruv Arya, Sunnyvale, CA (US)

(21) Appl. No.: 14/815,299

(22) Filed: Jul. 31, 2015

(51) Int. Cl. G06Q 10/10; G06Q 50/00; G06F 17/30

(52) U.S. Cl. CPC G06Q 10/1053; G06F 17/30424; G06F 17/30554; G06F 17/3053; G06Q 50/01

(57) ABSTRACT

A social networking system receives a search query from a user, and the system identifies entities as a function of the search query. The system retrieves attributes that are associated with the user, and retrieves attributes that are associated with the entities. The system determines matches between the attributes that are associated with the user and the attributes that are associated with the entities, and displays data relating to the entities and the matches on a computer display device.

### TECHNICAL FIELD

The present disclosure generally relates to the technical field of online social networking services, and in an embodiment, but not by way of limitation, to a search functionality of online social networking services, and more particularly, to displaying common attributes, which are also referred to as entity aware snippets, that are shared by a user/searcher of an online social networking service and entities that are located in a search of the online social networking service.

### BACKGROUND

An online social networking service, such as LinkedIn, allows members to declare information about themselves, such as their professional qualifications or skills. In addition to information the members declare about themselves, an online social networking service may gather and track information pertaining to behaviors of members with respect to the online social networking service and social networks of members of the online social networking service. Analyzing a vast array of such information may help to come up with solutions to various problems that may not otherwise have clear solutions.

### DESCRIPTION OF THE DRAWINGS

Some embodiments are illustrated by way of example and not limitation in the accompanying drawings, in which:

FIG. 1 is a block diagram of the functional modules or components that comprise a computer network-based online social networking service, including application server modules consistent with some embodiments of the invention;

FIG. 2 is a block diagram depicting some example application server modules of FIG. 1;

FIGS. 3A and 3B are a flow diagram illustrating an example method of searching an online social networking service and displaying with the search results common attributes shared by the searcher and entities that are located in the search;

FIG. 4A is an example user interface illustrating search results from a job search by a user of an online social networking service;

FIG. 4B is an example user interface illustrating search results from a job candidate search in an online social networking service by a job recruiter;

FIG. 4C is an example user interface illustrating search results from viewing a member's profile by a user of an online social networking service; and

FIG. 5 is a block diagram of a machine in the form of a computing device within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of the various aspects of different embodiments of the present invention. It will be evident, however, to one skilled in the art that the present invention may be practiced without all of the specific details and/or with variations, permutations, and combinations of the various features and elements described herein.

The present disclosure describes methods, systems, and computer program products for allowing a user of an online social networking service to search for entities in the online social networking service, and further for displaying common attributes (or entity aware snippets) between the user/searcher and the located entities. Entities can be, for example, members of the online social networking service, job postings in the online social networking service, and groups in the online social networking service. In an embodiment, the online social networking service receives a search query from a user for use in searching the online social networking service. The online social networking service performs a search using the search query, and identifies one or more entities in the online social networking service using the search query. The online social networking service retrieves one or more attributes that are associated with the user, and retrieves one or more attributes that are associated with the one or more entities that were located in the search. The online social networking service then determines one or more matches between the one or more attributes that are associated with the user and the one or more attributes that are associated with the one or more entities located in the search, and displays data relating to the one or more entities and the one or more matches on a computer display device. As noted above, these functionalities can be referred to as entity aware snippets, since the online social networking service is aware of the attributes of the user and the located entities, and information snippets that are displayed to the user include attributes that are shared by the user and the entities located in the search. These entity aware snippets improve the functioning of an online social networking service because they permit the online social networking service to convey to the user the reason why the displayed search results are relevant or important to the user.

Such entity aware snippets are supported and made possible by the functionalities and operations of the online social networking service. Specifically, a member of an online social networking service may declare one or more educational, professional, and/or personal interest qualifications or attributes. As a result, an online social networking service may have a vast array of information pertaining to other members, including data items pertaining to education, work experience, skills, interests, or other qualifications of each other member. A search of this information may discover common attributes between a user-searcher and the entities located in the search. The presentation of these common attributes in the search result makes the search results more valuable to the user.

In various embodiments, a back-end algorithm may be configured to identify the attributes of a member based on information that the member specifies about herself or himself and that is stored in the member's profile, information that the system collects pertaining to the member (e.g., behavior data, such as articles read, pages browsed, messages posted, connections made, or other actions), information about declared or acknowledged connections of a member (e.g., social graph data), and so on. After the attributes of the member have been identified, these attributes can be used to match attributes of any entity located in a search of the online social networking service by the user. These common or matched attributes can be presented to the member as snippets in a user interface. Various options for allowing the member to engage with these particular entities may then be presented to the member.

In various embodiments, a method of presenting entity aware snippets to a user of an online social networking service is disclosed. As noted above, a member of the online social networking service inputs a search query. The online social networking service, using profiles of other members of the online social networking service, identifies the other members of the online social networking service that match the search query. The online social networking service extracts attributes from the profile of the user and the profiles of the identified other members. The online social networking service then provides to the member information relating to the located entities and common attributes that the user has with the located entities.

Other advantages and aspects of the present inventive subject matter will be readily apparent from the description of the figures that follows.

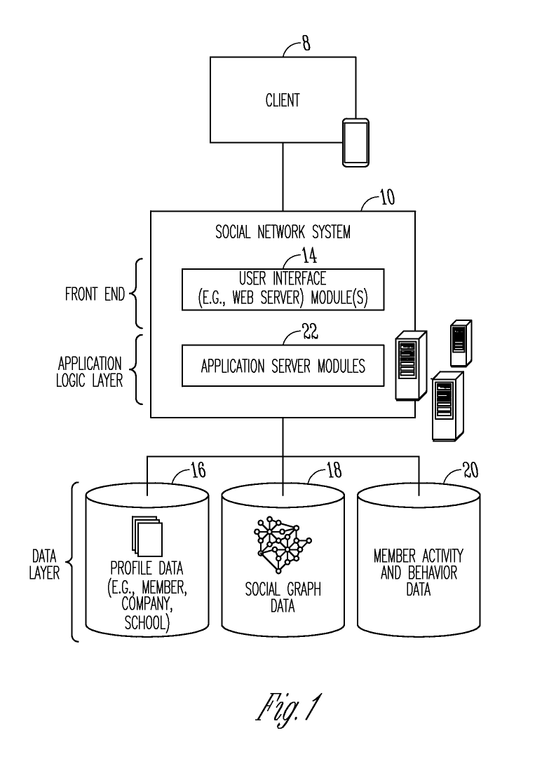

FIG. 1 is a block diagram of the functional modules or components that comprise a computer-based or network-based online social networking service 10 consistent with some embodiments of the invention. As shown in FIG. 1, the online social networking service 10 is generally based on a three-tiered architecture, comprising a front-end layer, application logic layer, and data layer, and can communicate with a client device 8. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with an online social networking service, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end comprises a user interface module (e.g., a web server) 14, which receives requests from various client-computing devices, and communicates appropriate responses to the requesting client devices. For example, the user interface module(s) 14 may receive requests in the form of Hypertext Transport Protocol (HTTP) requests, or other web-based, application programming interface (API) requests. The client devices may be executing conventional web browser applications, or applications that have been developed for a specific platform to include any of a wide variety of mobile devices and operating systems.

As shown in FIG. 1, the data layer includes several databases, including one or more databases 16 for storing data relating to various entities represented in a social graph. With some embodiments, these entities include members, companies, and/or educational institutions, among possible others. Consistent with some embodiments, when a person initially registers to become a member of the online social networking service, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's profile, for example, in the database with reference number 16. With some embodiments, a member's profile data will include not only the explicitly provided data, but also any number of derived or computed member profile attributes and/or characteristics.

Once registered, a member may invite other members, or be invited by other members, to connect via the online social networking service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data maintained in a database 18. With some embodiments a social graph data structure may be implemented with a graph database 18, which is a particular type of database that uses graph structures with nodes, edges, and properties to represent and store data. In this case, the social graph data stored in database 18 reflects the various entities that are part of the social graph, as well as how those entities are related with one another.

With various alternative embodiments, any number of other entities might be included in the social graph, and as such, various other databases may be used to store data corresponding with other entities. For example, although not shown in FIG. 1, consistent with some embodiments, the system may include additional databases for storing information relating to a wide variety of entities, such as information concerning various online or offline groups, job listings or postings, photographs, audio or video files, and so forth.

With some embodiments, the online social networking service may include one or more activity and/or event tracking modules, which generally detect various user-related activities and/or events, and then store information relating to those activities/events in the database with reference number 20. For example, the tracking modules may identify when a user makes a change to some attribute of his or her member profile, or adds a new attribute. Additionally, a tracking module may detect the interactions that a member has with different types of content. Such information may be used, for example, by one or more recommendation engines to tailor the content presented to a particular member, and generally to tailor the user experience for a particular member.

The application logic layer includes various application server modules 22, which, in conjunction with the user interface module(s) 14, generate various user interfaces (e.g., web pages) with data retrieved from various data sources in the data layer. With some embodiments, individual application server modules 22 are used to implement the functionality associated with various applications, services and features of the online social networking service. For instance, a messaging application, such as an email application, an instant messaging application, or some hybrid or variation of the two, may be implemented with one or more application server modules 22. Of course, other applications or services may be separately embodied in their own application server modules 22.

The online social networking service may provide a broad range of applications and services that allow members the opportunity to share and receive information, often customized to the interests of the member. For example, with some embodiments, the online social networking service may include a photo sharing application that allows members to upload and share photos with other members. As such, at least with some embodiments, a photograph may be a property or entity included within a social graph. With some embodiments, members of an online social networking service may be able to self-organize into groups, or interest groups, organized around a subject matter or topic of interest. Accordingly, the data for a group may be stored in a database. When a member joins a group, his or her membership in the group will be reflected in the social graph data stored in the database with reference number 18. With some embodiments, members may subscribe to or join groups affiliated with one or more companies. For instance, with some embodiments, members of the online social networking service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modeled with the social graph data of the database with reference number 18.

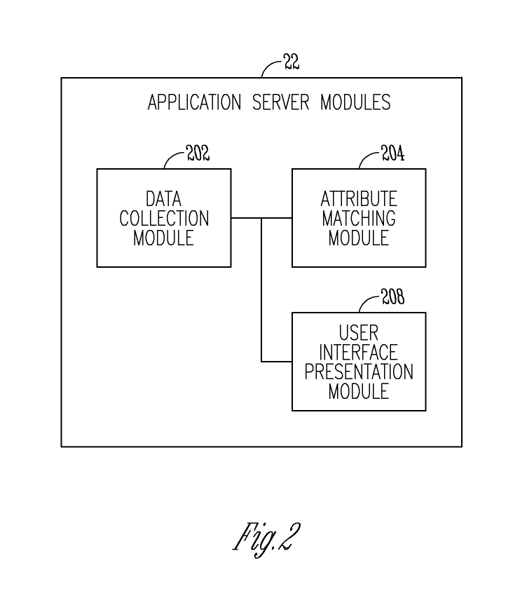

FIG. 2 is a block diagram depicting some example application server modules 22 of FIG. 1. A data collection module 202 may be configured to collect, for example, attributes corresponding to members and other entities such as groups, employers, and job postings of an online social networking service. Such data may include profile data, behavior data, endorsement data, and online social networking service data. An attribute matching module 204 may be configured to match up common attributes between a person executing a search on the online social networking service and the entities located in the search. Besides exact matching, inferences can be made relating to the searcher and the entities located in the search, and the inferences may be based on an application of a Hidden Markov Model (HMM) or various other algorithms. A user interface presentation module 208 may be configured to generate a user interface for presentation to the user. The user interface may include information pertaining to the entities located in a search of the online social networking service and attributes that are common between the user conducting the search and the entities located in the search.

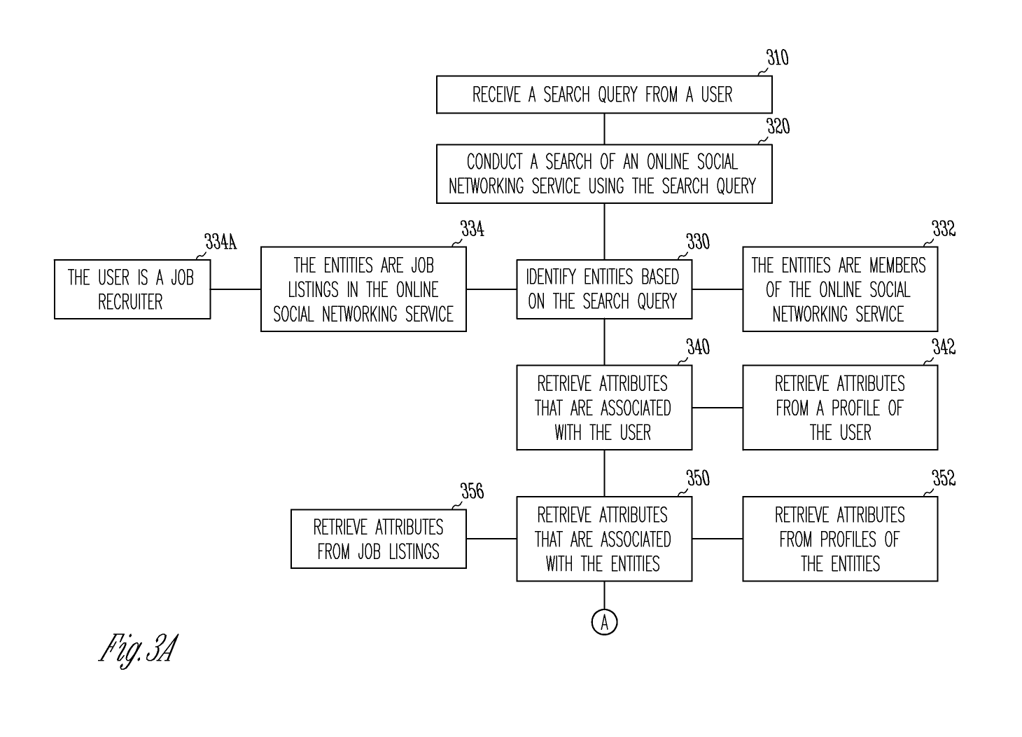

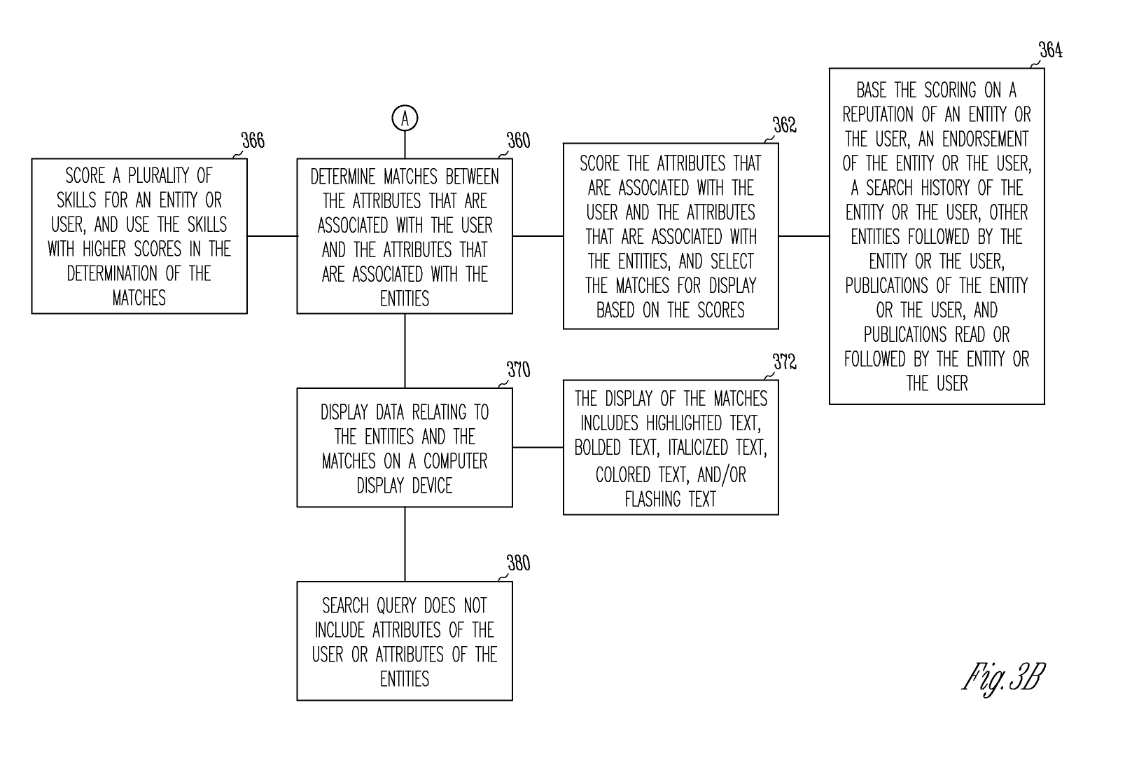

FIGS. 3A and 3B are a flow diagram illustrating an example method 300 of displaying to a user search results from a search of an online social networking service and entity aware snippets that are associated with the search. In various embodiments, the method 300 may be implemented by one or more of the modules of FIG. 2. FIGS. 3A and 3B include a number of process blocks 310-380. Though arranged somewhat serially in the example of FIGS. 3A and 3B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring specifically to FIGS. 3A and 3B, at 310, an online social networking service receives a search query from a user for use in searching on the online social networking service. The user is typically a member of the online social networking service. As discussed in more detail below, the user could be searching for a particular type of job, searching for a job at a particular company, checking the profile of another user, or any other function permitted by the online social networking service. At 320, the online social networking service conducts a search using the search query.

At 330, the online social networking service identifies entities based on the search query. As indicated at 332, the entities could be members of the online social networking service. For example, the user could simply be checking the profile of a member of the online social networking service. In another example, the user could be searching for alumni of his or her university who happen to work at a particular company. As indicated at 334, the entities could be job listings in the online social networking service. For example, a user could input as a search query “software engineer San Francisco Bay area,” and the online social networking service would return, among other entities perhaps, job openings for software engineers in the San Francisco Bay area. This functionality is particular useful to a professional job recruiter, as indicated at 334A.

After the search at 330, the online social networking service retrieves attributes that are associated with the user at 340, and retrieves attributes that are associated with the entities that were located in the search at 350. At 342, attributes are retrieved from a profile of the user. At 352, attributes are retrieved from profiles of the entities. When the search involves a job search, attributes can be retrieved from job listings in the online social networking service (356).

At 360, the online social networking service determines matches between the attributes that are associated with the user and the attributes that are associated with the entities that were located in the search. A match can be an exact match or similar match. In an embodiment, as indicated at 362, the online social networking service scores the attributes that are associated with the user and the attributes that are associated with the entities, and selects the matches for display based on the scores. As indicated at 364, the scoring may be based on a reputation of an entity or the user, an endorsement of the entity or the user, a search history of the entity or the user, other entities followed by the entity or the user, publications of the entity or the user, and publications read or followed by the entity or the user. For example, an entity and user may receive a certain amount of points for each endorsement in a particular subject area. Thereafter, that entity is more likely to be highlighted for that user when both the user and entity have high scores for endorsements in that particular subject area. For example, if a user and a company are both highly endorsed for Java, then it is more likely that the company will be highlighted in search results that are displayed to that user. Additionally, a skill level of a user can be inferred from data is his or her profile. For example, if a user has “Hadoop” and “Java” listed as skills in his or her profile, it can be inferred that that user also has “map reduce” as a skill. Such inferred skills can also be scored as described above.

Similarly, at 366, a plurality of skills for an entity or user is scored, and the skills with higher scores are used in the determination of the matches. A user may have several different subsidiary skills within his or her overall skill set. For example, a user may be skilled as a software engineer, with particular skills in Python and Java. However, while the user may have both Python and Java listed as skills within his or her profile, the user may be particularly skilled in Python. This greater skill level in Python could be determined by examining the endorsements that the user has received from members of the online social networking service, wherein such endorsements are for the user's skill in Python.

At 370, the online social networking service displays data relating to the entities and the matches on a computer display device. At 372, the display of the matches includes highlighted text, bolded text, italicized text, colored text, flashing text, and/or some other means of highlighting the entity data. This highlighting of the entity data (i.e., snippets) located in the search conveys to the user the reasons (i.e., search attribution) why the particular search result or snippet is important or relevant to the user.

At 380, it is indicated that the search query that was input by the user does not include either the attributes of the user or the attributes of the entities. In such a situation, the online social networking service is still intelligent enough to point out the reason that the search results are important to the user even though the user did not include the important term or piece of data in the search query. That is, a common attribute is determined between the user and the entity retrieved in the search even if that common attribute is not explicitly included in the search query. For example, a first user and a second user may both enter a search query that includes the term “software engineer.” The first user may have “Python” as a skill in his or her profile, and the second user may have “Java” as a skill in his or her profile. Additionally, a particular job listing may include both skills, that is, “Python” and “Java.” When the details of the particular job are displayed to both the first and second user as a result of their searches, the “Python” aspect of the particular job would be highlighted in some manner to the first user, and the “Java” aspect of the particular job would be highlighted in some manner to the second user, even though the first user did not include “Python” in his or her search query and the second user did not include “Java” in his or her search query.

In summary, an embodiment improves the functionality of an online social networking service by improving search results and the manner in which the search results are displayed to the user/searcher. As one of skill in the art realizes, improving searching on the Internet in general, and in an online social network service in particular, is important to the functionality and success of the online social networking service or other website. In short, the online social networking service functions in a much improved manner because improved search results are provided to users. Additionally, an embodiment improves the actual functioning of the computer because the online social networking service can return only relevant snippets to the user, and irrelevant or less relevant data need not be transmitted to the user over the online social networking service network.

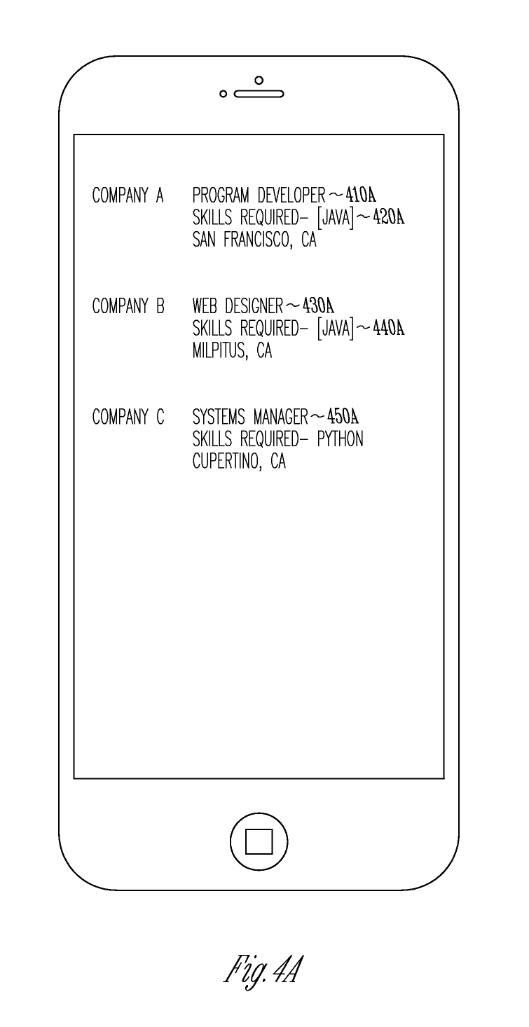

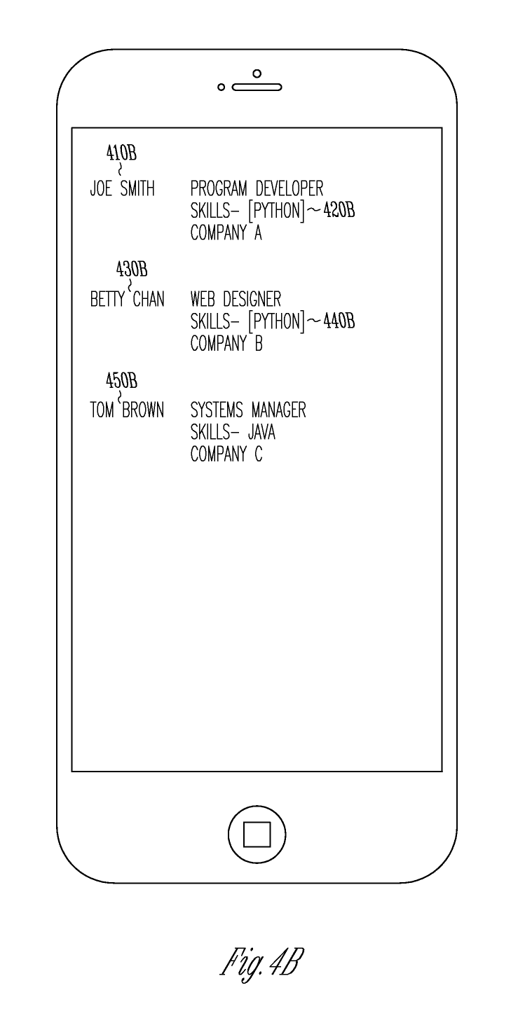

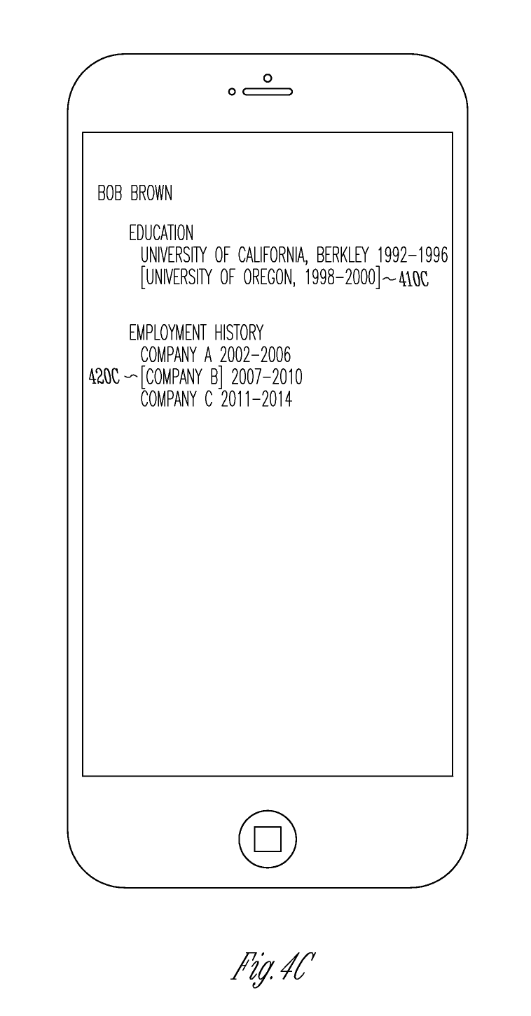

FIGS. 4A, 4B, and 4C illustrate example user interfaces for displaying entity aware snippets in search results in an online social networking service. FIG. 4A illustrates an example wherein a user searches for job openings for software engineers. The user may enter a query for a “software engineer,” and the online social networking service will search for and retrieve entities (e.g., job postings) for software engineers. After the retrieval, the online social networking service may determine from the user's profile that the user is highly rated or ranked for Java and Java systems. The online social networking service will then display job postings for the user, and will in some manner highlight a portion or portions of the snippet that displays “Java.” As noted before, this informs the user the reason why this particular snippet is relevant or important to the user. So, as illustrated in FIG. 4A, three jobs are displayed to the user for the search for “software engineer.” The first job listing 410A is for a program developer at Company A, and the required skills portion indicating “Java” is highlighted by bracketing at 420A. Similarly, the required skills portion for the second job listing 430A at Company B has the “Java” skill highlighted at 440A. Once again, this highlighting informs the user why this search result is important to the user. As further illustrated in FIG. 4A, the job listing 450A at Company C has nothing highlighted (e.g., no bracketing), because no matches were found between the user's profile and the job profile for Company C.

FIG. 4B illustrates an example wherein a user is a job recruiter, and the job recruiter is searching for potential job candidates for software engineering positions. The job recruiter may enter a query for a “software engineer,” and the online social networking service will search for and retrieve entities (e.g, members who have “software engineering” or some facsimile thereof in their profiles). After the retrieval, the online social networking service may determine from the job recruiter's search history that the job recruiter conducts a lot of searches, or browses through a lot of member profiles, having Python as a skill. The online social networking service can then infer that although the job recruiter entered “software engineering” as the search query, the search history of this job recruiter indicates that he or she is normally and/or particularly interested in candidates with Python skills (See FIG. 3B, No. 380). Consequently, the online social networking service will display potential job candidates to the job recruiter, and will in some manner highlight the portion of the candidates' snippets that display “Python.” As noted before, this informs the job recruiter the reason why this particular snippet of the candidate is relevant or important to the job recruiter. So, as illustrated in FIG. 4B, three potential candidates are displayed to the job recruiter for the candidate search for “software engineer.” The first job candidate 410B is for Joe Smith, and the skills possessed by Joe Smith have his Python skill highlighted by bracketing at 420B. Similarly, the skills possessed by job candidate 430B (Betty Chan) have the Python portion highlighted at 440B. Once again, this highlighting informs the user why this search result is important to the user. The third job candidate 450B (Tom Brown) has no skills highlighted (e.g., no bracketing), because there were no attribute matches between candidate 450B and the user (job recruiter).

FIG. 4C illustrates an example wherein a user has been asked by a member to connect. Before accepting the offer of a connection, the user may first want to view the profile of this member. Before displaying the member profile to the user, the online social networking service can retrieve attributes from the user's profile, attributes from the member's profile, and compare the two sets of attributes for matches or similar attributes. For example, both the user and member may have attended the University of Oregon, and the user may work at a company in which the member is interested (which can be determined for example by the member browsing the company website and applying for jobs at the company). Consequently, the online social networking service will display the member's profile to the user and highlight the member's attendance at the University of Oregon and the member's interest in the company. So, as illustrated in FIG. 4C, the profile of the member that is displayed to the user highlights by bracketing the University of Oregon at 410C and the member's interest in the company at 420C. These highlights indicate to the user the reason why the member may want to connect with the user.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

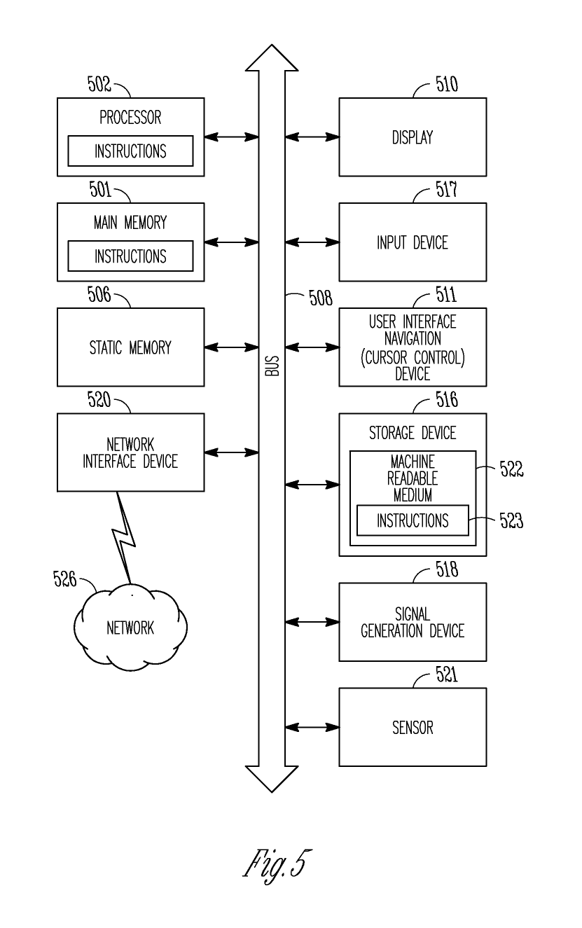

FIG. 5 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 501 and a static memory 506, which communicate with each other via a bus 508. The computer system 500 may further include a display unit 510, an alphanumeric input device 517 (e.g., a keyboard), and a user interface (UI) navigation device 511 (e.g., a mouse). In one embodiment, the display, input device and cursor control device are a touch screen display. The computer system 500 may additionally include a storage device 516 (e.g., drive unit), a signal generation device 518 (e.g., a speaker), a network interface device 520, and one or more sensors 521, such as a global positioning system sensor, compass, accelerometer, or other sensor.

The drive unit 516 includes a machine-readable medium 522 on which is stored one or more sets of instructions and data structures (e.g., software 523) embodying or utilized by any one or more of the methodologies or functions described herein. The software 523 may also reside, completely or at least partially, within the main memory 501 and/or within the processor 502 during execution thereof by the computer system 500, the main memory 501 and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 523 may further be transmitted or received over a communications network 526 using a transmission medium via the network interface device 520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A social networking system comprising:
a computer readable medium having instructions stored thereon, which, when executed by a processor, cause the system to:
receive a search query from a user for use in searching on the social networking system;
search the social networking system using the search query;
identify one or more entities in the social networking system as a function of the search query;
retrieve one or more attributes that are associated with the user;
retrieve one or more attributes that are associated with the one or more entities;
determine one or more matches between the one or more attributes that are associated with the user and the one or more attributes that are associated with the one or more entities; and
display data relating to the one or more entities and the one or more matches on a computer display device.

2. The social networking system of claim 1, wherein the one or more entities comprise members of the social networking system.

3. The social networking system of claim 1, wherein the one or more entities comprise job listings in the social networking system.

4. The social networking system of claim 3, wherein the user is a job recruiter.

5. The social networking system of claim 1, wherein the instructions cause the system to score one or more of the attributes that are associated with the user and the attributes that are associated with the entities; and to select the matches for display based on the scores.

6. The social networking system of claim 5, wherein the scoring is based on one or more of a reputation of an entity or the user, an endorsement of the entity or the user, a search history of the entity or the user, other entities followed by the entity or the user, publications of the entity or the user, and publications read or followed by the entity or the user.

7. The social networking system of claim 6, wherein a plurality of skills for an entity or user is scored, and the skills with higher scores are used in the determination of the one or more matches.

8. The social networking system of claim 1, wherein the attributes are retrieved from one or more of profiles of the entities or the user in the social networking system and job listings in the social networking system.

9. The social networking system of claim 1, wherein the display of the matches comprises one or more of highlighted text, bolded text, italicized text, colored text, and flashing text.

10. The social networking system of claim 1, wherein the search query does not include either of the one or more attributes of the user or the one or more attributes of the one or more entities.

11. A method comprising:
receiving a search query from a user for use in searching on an online social networking service;
searching the online social networking service using the search query;
identifying one or more entities in the online social networking service as a function of the search query;
retrieving one or more attributes that are associated with the user;
retrieving one or more attributes that are associated with the one or more entities;
determining one or more matches between the one or more attributes that are associated with the user and the one or more attributes that are associated with the one or more entities; and
displaying data relating to the one or more entities and the one or more matches on a computer display device.

12. The method of claim 11, wherein the one or more entities comprise members of the online social networking service.

13. The method of claim 11, wherein the one or more entities comprise job listings in the online social networking service; and wherein the user is a job recruiter.

14. The method of claim 11, wherein the instructions cause the online social networking service to score one or more of the attributes that are associated with the user and the attributes that are associated with the entities; and to select the matches for display based on the scores.

15. The method of claim 14, wherein the scoring is based on one or more of a reputation of an entity or the user, an endorsement of the entity or the user, a search history of the entity or the user, other entities followed by the entity or the user, publications of the entity or the user, and publications read or followed by the entity or the user.

16. The method of claim 14, wherein a plurality of skills for an entity or user is scored, and the skills with higher scores are used in the determination of the one or more matches.

17. The method of claim 11, wherein the attributes are retrieved from one or more of profiles of the entities or the user in the online social networking service and job listings in the online social networking service.

18. The method of claim 11, wherein the display of the matches comprises one or more of highlighted text, bolded text, italicized text, colored text, and flashing text.

19. A social networking system comprising:
a computer processor and a computer storage device configured to:
receive a search query from a user for use in searching on the social networking system;
search the social networking system using the search query;
identify one or more entities in the social networking system as a function of the search query;
retrieve one or more attributes that are associated with the user;
retrieve one or more attributes that are associated with the one or more entities;
determine one or more matches between the one or more attributes that are associated with the user and the one or more attributes that are associated with the one or more entities; and
display data relating to the one or more entities and the one or more matches on a computer display device.

20. The social networking system of claim 19,
wherein the instructions cause the system to score one or more of the attributes that are associated with the user and the attributes that are associated with the entities; and to select the matches for display based on the scores;
wherein the attributes are retrieved from one or more of profiles of the entities or the user in the social networking system and job listings in the social networking system; and
wherein the display of the matches comprises one or more of highlighted text, bolded text, italicized text, colored text, and flashing text.
